(19) United States
(12) Patent Application Publication
(10) Pub. No.: US 2008/0216763 A1
(43) Pub. Date: Sep. 11, 2008

(54) Scratching Device

(76) Inventor: Michael A. Ebert, St. Marys (CA)

Correspondence Address: Michael Ebert, RR 3, 17563 Gregory Dr., St. Marys, N4X 1C6, CA

(21) Appl. No.: 11/684,487

(22) Filed: Mar. 9, 2007

(51) Int. Cl. A01K 15/02

(52) U.S. Cl. 119/706

(57) ABSTRACT

A scratching device is provided comprising a support base that is shaped to allow a like base to be stacked thereon and a post having a scratchable surface that extends upwardly from the support base. The base advantageously allows the device to be readily stacked for storage.

### FIELD OF THE INVENTION

The present invention relates to scratching devices for pets, and in particular, to a stackable scratching post.

### BACKGROUND OF THE INVENTION

Scratching devices such as scratching posts for clawed pets, e.g. cats, are generally known in the art. Such devices attempt to provide an alternative to furniture, and other valuables within a home, that is attractive to a pet for scratching and stretching, thereby preventing or minimizing damage to furniture.

One such scratching post is described by Cook in U.S. Pat. No. 4,177,763. This particular scratching post comprises a detachable post to permit convenient storage thereof from day to day, to render the scratching post more portable, and to minimize space usage and packaging on the retail side.

The design of scratching devices which serve the dual role of scratching post and furniture protector are particularly desirable. Birmingham describes a device in U.S. Pat. No. 5,592,901 including a protective frame that functions to protect at least a portion of a piece of furniture as well as providing a scratching surface. In addition, the device includes a holding member attached to the protective frame to maintain the frame in position up against a piece of furniture. The holding member may be an outwardly extending foot that can be inserted between a leg of the piece of furniture and the floor to hold the device in place. A similar scratching post is described in U.S. Pat. No. 5,619,953 to Griffin.

It would be desirable to provide a scratching device that improves upon those provided in the prior art with respect to utility and/or storage options, particularly at the retail stage.

### SUMMARY OF THE INVENTION

Thus, in one aspect of the present invention, there is provided a scratching device for use by a pet, said device comprising:
a support base that is stackable with a like base; and
a post extending from the support base in an upward direction, said post having a scratchable surface.

The stackable feature of the present scratching device is particularly desirable to minimize space usage of the devices in, for example, a retail showroom, in retail storage or during shipping.

In another aspect of the present invention, a self-supporting scratching device is provided comprising:
a support base; and
a post extending from the support base in an upward direction, said post having a scratchable surface,
wherein said base is shaped to permit placement of the post against an item to be protected.

Embodiments of the invention will become apparent in the description that follows, and in the drawings in which:

### BRIEF DESCRIPTION OF THE DRAWINGS

FIG. 1 illustrates a side view (A) and a perspective view (B) of a scratching device in accordance with an embodiment of the invention;

FIG. 2 is a top view of the device of FIG. 1;

FIG. 3 illustrates by top view complementarity between the shape of support base and the shape of the front side of a post of a pair of scratching devices (A) and the devices when in a stacked position (B);

FIG. 4 illustrates a side view of first (A), second (B), and third (C) stackable embodiments according to the invention;

FIG. 5 illustrates a support base having an indented shape along the back edge thereof; and

FIG. 6 illustrates vertical (A) and horizontal (B) positions of a scratching device.

### DETAILED DESCRIPTION OF THE INVENTION

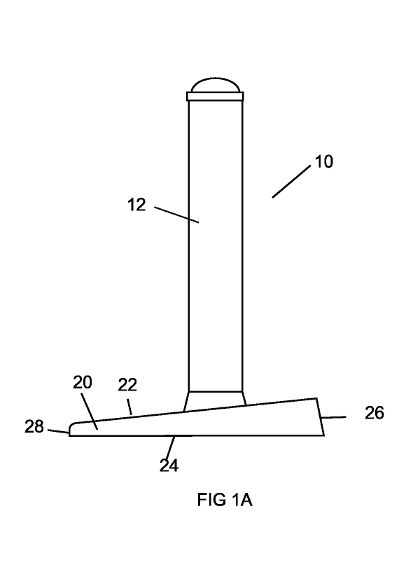

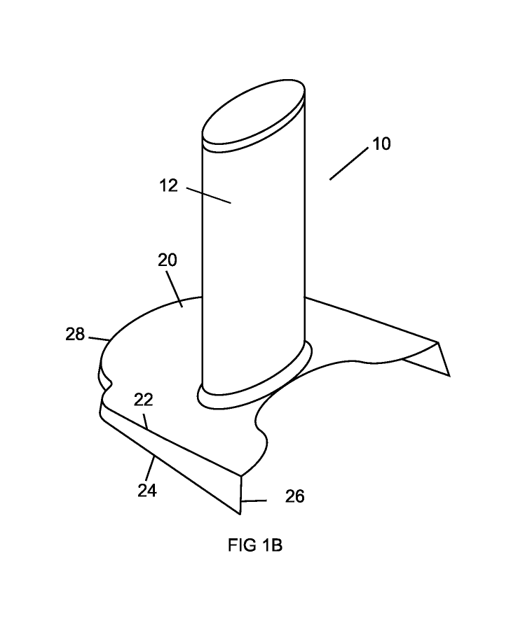

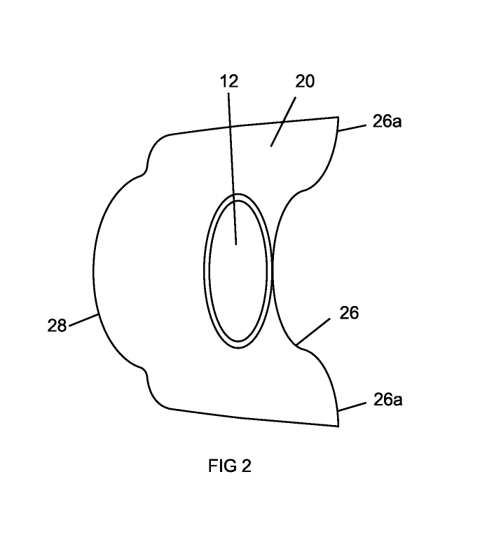

A scratching device 10 is provided as shown in FIGS. 1 and 2 comprising a post 12 and a base 20 which supports the post 12.

The post 12 extends in a generally upward direction from base 20. The term “upward direction” refers not only to a post 12 which is substantially upright with respect to base 20, but also refers to a post 12 that extends at an angle from base 20, provided the degree of angling does not interfere with the function of the post 12 to provide a desirable scratching site. As shown, the post may be cylindrical-like in shape, but as will be appreciated, is not restricted with respect to shape and thus, may have any regular or irregular geometric shape appropriate for its use as a post for scratching. In addition, the post 12 may include curves and/or projections that may increase its attraction to a pet, and thereby, increase its utility. The post 12 may also be shaped, for example, to cover the edge, corner or leg of a piece of furniture, or to cover a protruding wall corner.

The surface of post 12 comprises a material suitable to satisfy the scratching and clawing behaviour of cats, and perhaps other clawed pets. Generally, the material is such that it will allow the pet to dig its claws into it. Examples of suitable materials include, but are not limited to, fabric, cloth, textile, carpet, sisal, durable padding, cardboard including corrugated cardboard, and other like materials. The post 12 may be made entirely of a selected scratchable material if it has sufficient rigidity to form a post that will maintain its shape and provide sufficient support to a scratching/clawing pet. In this regard, the post 12 may be made of a material such as carpet tile. Alternatively, the post 12 may itself be made of a substance rigid enough to maintain its shape, and then be covered with a material suitable for scratching.

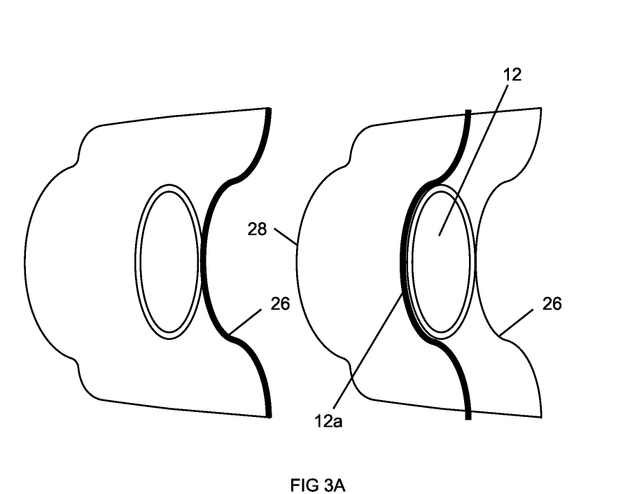

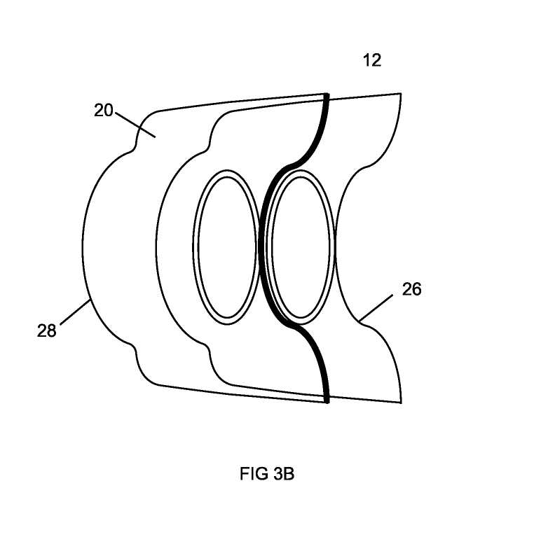

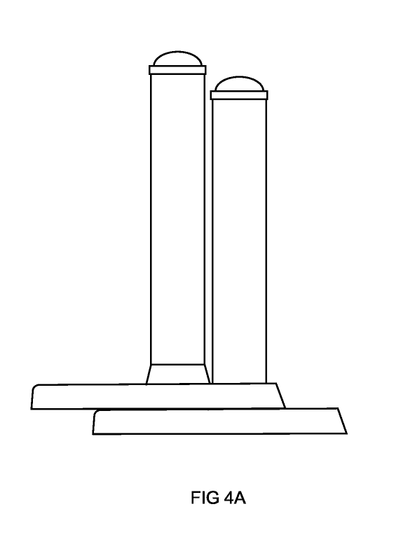

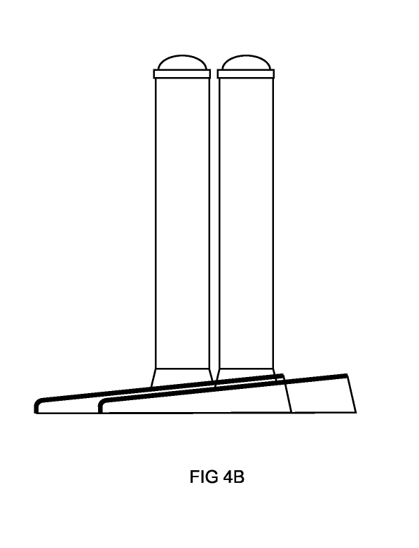

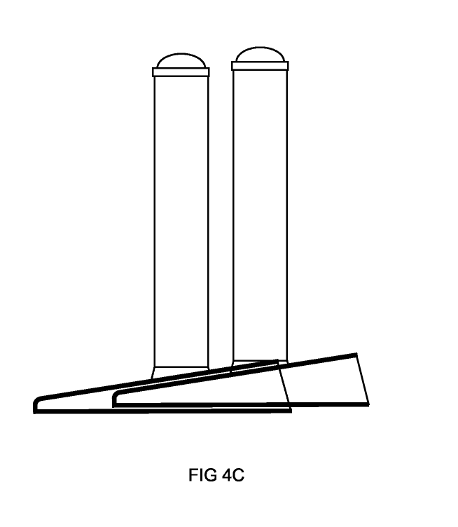

The base 20 is generally shaped to support the post 12 and to be stackable with a like base. The back edge 26 of base 20 is shaped to accommodate post 12 as shown in FIG. 3A. In this regard, the back edge 26 of the base 20 is shaped to complement the shape of the post 12 at its front side 12a, i.e. the side of the post that is facing the front edge 28 of the base 12. As outlined above, the post 12 may take on any one of a variety of shapes, and thus, the back edge 26 may similarly take on a variety of shapes to complement the shape of the post 12 at its front side 12a. The complementary shaping of the back edge 26 of the base 20 to the front side of the post 12a facilitates the stackability of the device 10 with another like device 10, by allowing the closest fit between stacked devices 10 as shown in FIG. 3B. As used herein, the term “stackable” refers to a base that can either be readily piled onto a like base as shown in FIG. 4A, or a base that can be seated or nested within a like base as shown in FIG. 4B or within a base as shown in FIG. 4C.

The base 20 comprises a top surface 22 and a bottom surface or bottom supporting edge 24. The contour of the top surface 22 is not particularly restricted provided that it renders the base stackable with a like base. Generally, to permit stacking of like bases, the top surface 22 is complementary to the bottom surface 24 such that the bottom surface 24 of one base 20 can rest or be seated stably onto the top surface 22 of another base 20. In one embodiment, as shown in FIG. 4A, the top and bottom surfaces (22, 24) of the base 20 are each flat and horizontal such that the bottom surface 24 of a first base can be seated stably on a supporting surface (e.g. the floor), and the bottom surface 24 of a second base 20 can be stably seated on the top surface 22 of the first base 20, and so on. In this way, two or more bases 20 can be stacked one on top of another to form a pile of stacked devices 10. As one of skill in the art will appreciate, in order to be stable in a stacked position, the top surface 22 of the base 20 is of a surface area that is sufficient to support a like base and to support the weight of the device 10.

In another embodiment, shown in FIG. 4B, the base 20 is hollow, lacking a bottom surface but instead having a bottom supporting edge 24. The bottom supporting edge 24 extends around at least a portion of the perimeter of the base and supports the weight of the device 10. The back edge 26 is open and is shaped to permit the top surface 22 of a first base 20 to be seated within or to nest within the bottom supporting edge 24 of a second base 20. In this case, the base 20 may be shaped similar to the base shown in FIG. 4A in which the top surface 22 of the base is flat and horizontal, and the bottom supporting edge 24 is parallel to the top surface 22. However, as set out above, contour of the top surface 22 may vary, and thus, may include some degree of curvature. The top surface 22 of the base may also be tapered downwardly from the back of the base to the front of the base as shown in FIG. 4B. In this regard, the base 20 may include a stepped decrease in height from the back of the base to the front of the base, or may include a sloping decrease in height. Tapering of the base may facilitate stacking of like bases 20 of the present scratching devices 10.

In another embodiment, shown in FIG. 4C, the base 20 is hollow including a bottom surface 24 and an open back edge 26. The back edge 26 is shaped to permit a like second base 20 to be seated within or to nest within a first base 20. As set out above, the shape of the base 20 is not restricted provided it permits nesting of a like base. Accordingly, the base 20 may be similar to the base shown in FIG. 4A in which the top and bottom surfaces 22, 24 of the base are flat and horizontal, or the top surface 22 may include some degree of curvature or tapering.

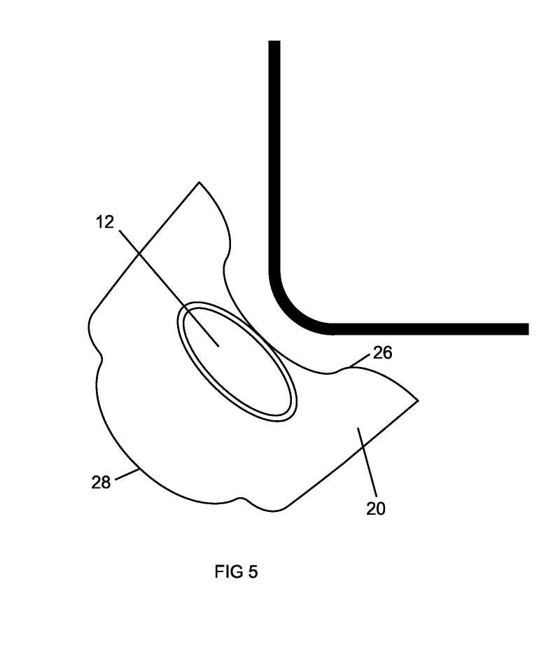

The back edge 26 of the base 20 may be shaped, for example indented, to permit its placement up against an item to protect the item from being scratched. Such items include, but are not limited to, furniture such as the corner or leg of a couch or chair, or a protruding wall corner as shown in FIG. 5. The back edge 26 of base 20 may be generally indented in shape with a curved or corner indenture for all-purpose use with any piece of furniture, wall corner or protrusion. Alternatively, the back edge 26 of base 20 may be shaped to specifically fit up against a particular item of furniture or wall protrusion. In any case, the scratching device 10 is self-supporting when placed up against an item it is meant to protect and does not need to be held in position up against the item by any additional means, or by the selected item itself.

The post 12 and base 20 of device 10 may be integrally formed, i.e. having no joints or points of attachment, or the post 12 and base 20 may be individual components that have been fastened together. In this regard, the post 12 and base 20 may be permanently fastened together, by any suitable fastening means (e.g. adhesive, screws, etc.), or may be detachably fastened together such that the post 12 and base 20 are separable for convenient storage thereof or for portability. Such detachable fastening of the post 12 to the base 20 may be accomplished by numerous means including hinged clips, adhesive material such as Velcro, or removable fasteners. It may also be accomplished by sizing the post to fit snugly within the base to maintain its position therein without additional fastening means.

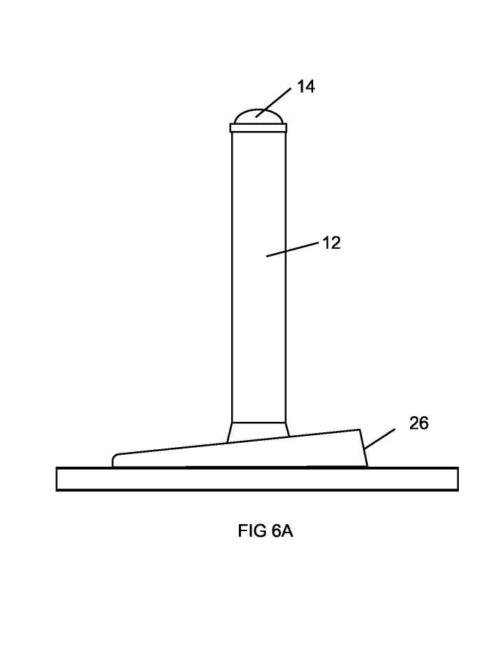

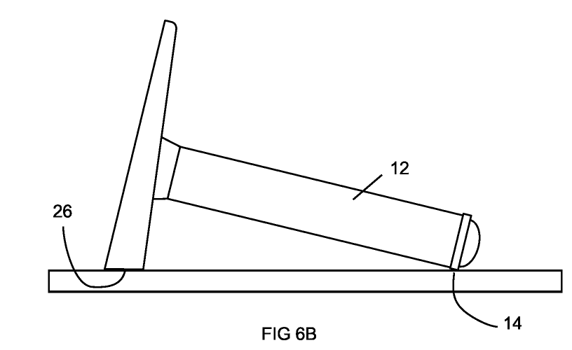

The present scratching device 10 may also be adapted for use in a horizontal position as shown in FIG. 6B. This configuration of the device 10 is obtained simply by placing the device 10 on its side such that the back edge 26 of the base 20 is supporting the device 10. In order for the device 10 to sit flatly on the ground (or other supporting surface), the edge 26 may be slightly angled to lay flat when the device is laid horizontally and the top 14 of the post 12 is resting on the ground. As one of skill in the art will appreciate, the angle of back edge 26 will vary with the height of post 12 such that the greater the height of post 12, the less the angle required on back edge 26 in order for the edge 26 to lay flat on the ground. In the case of a base with an indented back edge 26, only the portion of the back edge 26 that touches the ground in the horizontal position needs to be angled for the base to lay flat on the ground. For example, for an indented base as shown in FIG. 2, the outer ends 26a of the back edge 26 will only come in contact with the ground when in the horizontal position. Accordingly, for this base to lay flat on the ground, the edge of the outer ends 26a only need to be angled.

The foregoing description relates to certain embodiments of the invention; however, as one of skill in the art will appreciate, other embodiments may exist which fall within the scope of the appended claims.

We claim:

1. A scratching device comprising:
a support base, said base being stackable with a like base; and
a post extending from the support base in an upward direction, said post having a scratchable surface.

2. A scratching device as defined in claim 1, wherein the base is hollow.

3. A scratching device as defined in claim 1, wherein the base has a top surface and a bottom surface, the top surface being suitable to stably support the bottom surface of a like base.

4. A scratching device as defined in claim 2, wherein the base is tapered downwardly from the back of the base to the front of the base.

5. A scratching device as defined in claim 1, wherein the base is shaped to permit placement of the post against an item to be protected.

6. A scratching device as defined in claim 5, wherein the base comprises a back edge having an indented shape.

7. A scratching device as defined in claim 6, wherein the back edge of the base is shaped to complement an item to be protected.

8. A scratching device as defined in claim 1, wherein the post is detachable from the base.

9. A scratching device as defined in claim 1, wherein at least a portion of the back edge is angled such that the edge lays flat on the ground when the device is in a horizontal position and the top of the post is laid on the ground.

10. A scratching device as defined in claim 1, wherein the post is made of a rigid material that provides a scratchable surface.

11. A scratching device as defined in claim 10, wherein the post is made of carpet tile.

12. A self-supporting scratching device comprising:
a support base; and
a post extending from the support base in an upward direction, said post having a scratchable surface,
wherein said base is shaped to permit placement of the post against an item to be protected.

13. A scratching device as defined in claim 12, wherein said base comprises a back edge having an indented shape.

14. A scratching device as defined in claim 12, wherein the back edge of the base is shaped to complement an item to be protected.

15. A scratching device as defined in claim 12, wherein the post is detachable from the base.

16. A scratching device as defined in claim 12, wherein the post is made of a rigid material that provides a scratchable surface.

17. A scratching device as defined in claim 16, wherein the post is made of carpet tile.
